(19) United States
(12) Patent Application Publication
(10) Pub. No.: US 2026/0021532 A1
(43) Pub. Date: Jan. 22, 2026

(54) SYSTEMS AND METHODS FOR ANOMALY DETECTION DURING ADDITIVE MANUFACTURING PROCESSES

(71) Applicant: Rensselaer Polytechnic Institute, Troy, NY (US)

(72) Inventors: Alvin Chen, Troy, NY (US); Fotios Kopsaftopoulos, Niskayuna, NY (US); Sandipan Mishra, Niskayuna, NY (US)

(73) Assignee: Rensselaer Polytechnic Institute, Troy, NY (US)

(21) Appl. No.: 18/668,708

(22) Filed: May 20, 2024

Related U.S. Application Data
(60) Provisional application No. 63/467,698, filed on May 19, 2023.
(60) Provisional application No. 63/649,089, filed on May 17, 2024.

(51) Int. Cl. B22F 10/80; B33Y 50/00; G06T 7/00

(52) U.S. Cl. CPC B22F 10/80; B33Y 50/00; G06T 7/0004; G06T 2207/30164

(57) ABSTRACT

The systems and methods monitor additive manufacturing using a statistical time-frequency domain algorithm. Some embodiments utilize the periodicity of the scan-line (or “raster”) pattern of the laser in an additive manufacturing machine to define a nominal performance baseline for the machine in the time-frequency domain. The nominal basis is established by processing a series of images of the melt pool of the machine during scanning by the laser and converting this data to a spectrogram. The operation of the machine can then be monitored against this nominal basis in substantially real-time in some embodiments by comparing the spectrogram generated from operational data to the nominal basis.

### CROSS-REFERENCE TO RELATED APPLICATIONS

This application claims the benefit of U.S. Provisional Patent Application No. 63/467,698, filed May 19, 2023, and U.S. Provisional Patent Application No. 63/649,089 filed May 17, 2024, which are incorporated by reference as if disclosed herein in their entireties.

### STATEMENT REGARDING FEDERALLY SPONSORED RESEARCH OR DEVELOPMENT

This invention was made with government support under contract number 1645648 awarded by the National Science Foundation Data-Driven Cyberphysical Systems, and by the State of New York ESD/NYSTAR program, and in part under contract number 2222250 awarded by the National Science Foundation under CMMI. The government has certain rights in the invention.

### BACKGROUND

Additive manufacturing excels at fabrication of abstract shapes that may be too time consuming to traditionally manufacture and also in rapid prototyping applications. One family of AM is laser powder bed fusion (L-PBF), where build material, such as metal powder, is sintered together by a focused laser on a platform. Although this build environment is a controlled atmosphere, the process is very prone to defects. These anomalies can negatively impact the final print structure by reducing the ultimate tensile strength and other mechanical properties or affecting the surface qualities. These defects can manifest in-process as over-melting, keyhole defects, and spatter due to the energy deposition rate. Consequently, tight scan patterns from varying geometry may influence the local energy density in brief instances, leading to improper behavior. As such, sensing abnormalities in real time is important to furthering print accuracy.

The AM process can be monitored with a variety of approaches, each characterizing different aspects of the process. One popular method is through layer-wise image detection, classifying faults on a per-layer basis. These algorithms detect physical faults printed between layers through the analysis of the surface quality or through the comparison to a reference. These faults generally fall within the class of surface or contour defects, where either not enough or too much material is deposited, causing an inconsistency in shape. Layer-wise methods are excellent at part quality analysis but are not applicable for a real-time process control application. In contrast, quicker real time models have also been considered, such as acoustic detection methods which are able to monitor the system in-situ. Acoustic methods are well-suited for detecting cracks and voids that form during the AM process, though they cannot capture the thermal dynamics of the process well. Another in-situ method that is commonly used in fault detection is the analysis of the melt pool thermal signal. This is primarily performed using thermal or near infrared (NIR) imaging using either a thermal camera or pyrometer. The time series signal is then analyzed to determine defects. As the thermal signal captures melt pool data, these methods are adept at detecting over and under melting, as well as voids. Classification is typically performed by a neural network method, though others have used clustering techniques. However, many of these models use black box methods, which are not easily interpretable. Accordingly, these models have difficulty translating to geometry agnostic applications, as they must be trained on specific system behavior.

What is desired, therefore, are systems, methods, and devices for improved monitoring of AM processes for anomaly detection.

### SUMMARY

Some embodiments of the present technology are directed to systems for monitoring additive manufacturing processes using a statistical time-frequency domain algorithm. Some embodiments utilize the periodicity of the scan-line (or “raster”) pattern of the laser in an AM machine to define a nominal performance baseline for the machine in the time-frequency domain. The nominal basis is established by processing a series of images of the melt pool of the machine during scanning by the laser and converting this data to a spectrogram. The operation of the machine can then be monitored against this nominal basis in substantially real-time in some embodiments by comparing the spectrogram generated from operational data to the nominal basis. Thus, in some embodiments, the present technology is adapted for online application—anomaly detection can be performed while the AM machine is running, and with low time lag between data acquisition and identification of an anomaly.

In some embodiments, the comparison between the operation of the machine and the nominal basis is based on a statistical threshold: an operational spectrogram with high reconstruction error statistically does not resemble the nominal basis, indicating that the spectrogram contains an anomaly. In some embodiments, the statistical threshold is selected by a user to have a low probability of returning a false alarm.

Other embodiments of the present technology are directed to methods for monitoring additive manufacturing processes via a statistical time-frequency domain algorithm. Other embodiments include software products, stored on non-transitory computer-readable media, for performing the operations and methods described herein.

Various embodiments of the technology will now be described with reference to the drawings.

### BRIEF DESCRIPTION OF THE DRAWINGS

The drawings show embodiments of the disclosed subject matter for the purpose of illustrating the technology. However, it should be understood that the present application is not limited to the precise arrangements and instrumentalities shown in the drawings, wherein:

FIG. 1 shows a schematic view of a system according to one embodiment of the present technology.

FIG. 2 shows sample melt-pool image sequences, in which the top row shows images of nominal performance and the bottom row shows images of anomalous performance.

FIG. 3a shows three scan line patterns employed in an embodiment of the present technology; FIG. 3b shows the time series data for the melt pool intensity associated with each scan line pattern in FIG. 3a; FIG. 3c shows a chart of the autocorrelation function associated with each time series data in FIG. 3b.

FIG. 4 shows a flow chart of processing steps on the time series data from the autocorrelation function through the power spectral density to a spectrogram according to an embodiment of the present technology.

FIG. 5 shows spectrograms of sample layers formed using a L-PBF process according to the present technology, in which the top row shows nominal spectrograms and the bottom row shows spectrograms with anomalous features.

### DETAILED DESCRIPTION

Some embodiments of the present technology provide unsupervised monitoring of AM processes using a time-frequency domain approach to detect faults. First, in some embodiments, to streamline the method for in situ sensing, a sequence of near-infrared (NIR) images are compressed to a single-valued time series. This time series is then converted to the time-frequency domain as a spectrogram. This spectrogram contains geometry-dependent frequency content that is not easily detected in the time series. Using this information, some embodiments of the present technology learn the nominal behavior in the frequency domain by observing features of the spectrogram. In some embodiments, a principal component analysis (“PCA”) is used to accomplish this, as it is sufficiently robust to detect relevant faults. Other data-driven approaches are used in other embodiments. As used herein, the term “nominal” refers to the normal or acceptable operation of an AM machine or process—i.e., a operation that does not result in significant anomalies or faults.

From the PCA decomposition, a collection of bases from a combined nominal dataset of candidate raster geometries are generated in some embodiments. These bases characterize the nominal features of the spectrogram. To determine the health of in situ data, the spectrogram is compared to this nominal set of bases. In some embodiments, this is accomplished by combining the principal components (PCs) of spectrograms with the nominal basis set to create a reconstructed spectrogram. If the reconstructed spectrogram is not similar to the original, the spectrogram contains features that are unable to be reconstructed by the basis set. This implies that the spectrogram is anomalous, as faults will appear in the spectrogram as anomalous signals that do not share features with the nominal response. In some embodiments, then, the error between the reconstructed spectrogram and the original is used as the detection metric. Nominal spectrograms generally produce a low reconstruction error, whereas anomalous data generally exhibit a high reconstruction error. In some embodiments, a statistical test is then formed, with a detection threshold determined from data derived from acceptable operation of the machine. A reconstruction error outside the threshold implies that the corresponding spectrogram is disparate compared to the expected nominal response and therefore a fault is present in the spectrogram.

Furthermore, methods and systems in some embodiments of the present technology learns nominal behavior, so no labeling is required. Methods and systems in some embodiments can be trained on a small dataset, as a large quantity of data to learn nominal behavior is not required.

As described herein and in the incorporated materials, some embodiments of the present technology employ spectrograms of the time series melt pool response in an AM process to characterize the geometric properties. This correlates print geometry with incoming melt pool data (processed into the spectrogram), resulting in better knowledge of the process. Some embodiments provide a method for fault detection in AM that can be generalized to unique geometries. Some embodiments include a detection metric based on healthy operation of the AM system, reducing the data labeling requirements. Some embodiments use a statistical detection metric to determine anomalies and quantify faults.

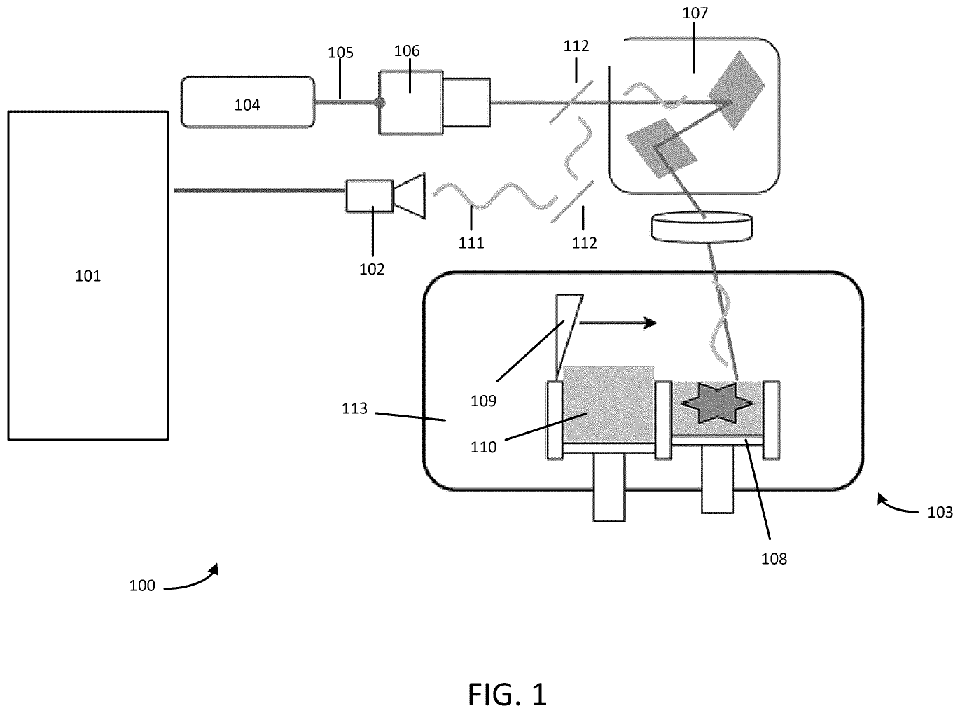

Some embodiments of the present technology are directed to a system for monitoring an additive manufacturing process. FIG. 1 shows a schematic representation of a first embodiment of the present technology.

In the embodiment shown in FIG. 1, the system 100 comprises a computer 101 and a camera 102. In this embodiment, the computer includes a processor and a computer-readable storage medium. In other embodiments, the system may be configured to access remote processor(s) and/or storage medium components. In some embodiments, the processor includes a plurality of processing units, which includes, but is not limited to, general-purpose processing units, graphical processing units, parallel processing units, etc. In some embodiments, the computer-readable storage medium includes one or more of the following types of memory: semiconductor firmware memory, programmable memory, non-volatile memory, read only memory, electrically programmable memory, random access memory, flash memory, magnetic disk memory, and/or optical disk memory. Either additionally or alternatively system memory may include other and/or later-developed types of computer-readable memory.

In some embodiments, the system 100 further includes or is associated with an AM machine 103, which is represented schematically in FIG. 1. In some embodiments, such as the embodiment shown in FIG. 1, the AM machine is an L-PBF machine. The L-PBF machine 103 comprises a laser 104 which produces a beam 105 that is directed by a collimator 106 to a scanner 107. The scanner 107 moves the laser across a build platform 108, on which metal powder is deposited by a recoater 109 from a powder reservoir 110. In some embodiments, the build platform 108, recoater 109, and powder reservoir 110 are housed within a process chamber 113.

In some embodiments, the system 100 includes equipment for directing the camera 102's optical path 111 to be co-axial with the laser beam 105. In some embodiments, this equipment comprises one or more mirrors 112, as shown in the exemplary embodiment in FIG. 1. The camera 102 is adapted to supply image data to the computer 101, via a hard wired communication connection or a wireless connection. In other embodiments, an off-axis camera is used.

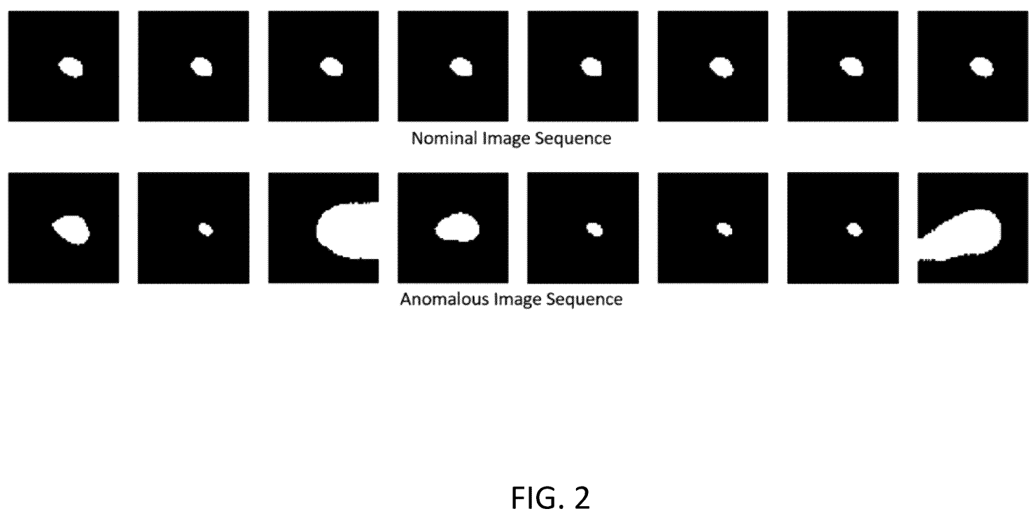

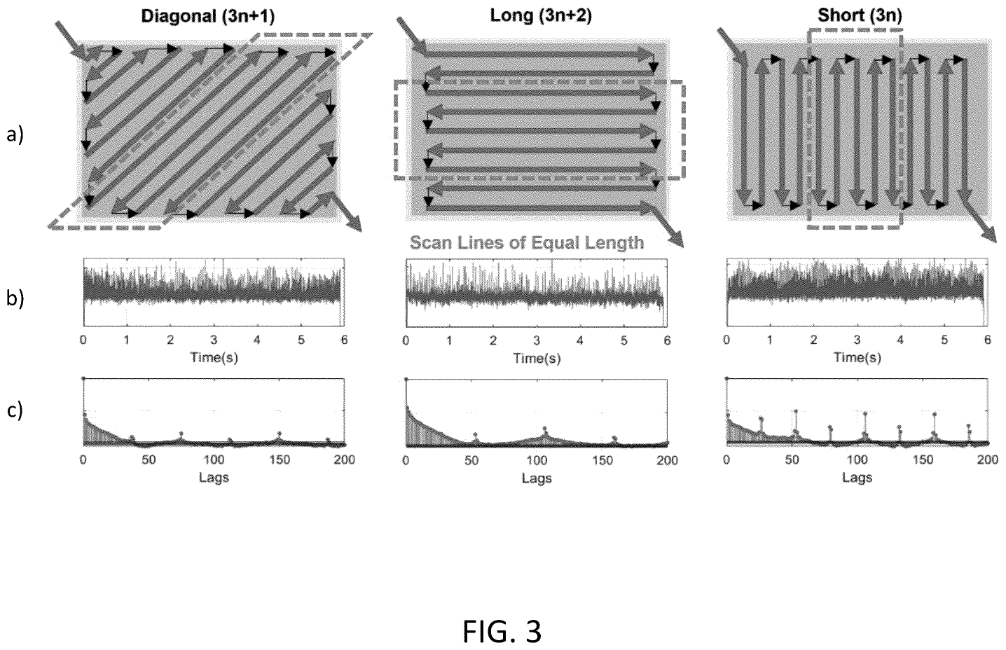

As the laser 104 scans across the build platform 108 during the L-PBF process, a melt pool forms, fusing metal powder together. Sample laser scan line patterns (also referred to as raster patterns) are shown in FIG. 3a. When anomalies or faults occur during this process, they are observable in the melt pool images. The camera 102 obtains an image sequence of the melt pool during the print. When a fault occurs, the corresponding melt pool image is different from images obtained during healthy process conditions. This manifests as an altered shape, such as a larger/smaller melt pool size, or as separated blobs, to list a few examples. Sample nominal and anomalous melt pool images are shown in FIG. 2. The nominal response consists of a uniform melt pool size and shape, whereas the anomalous images fluctuate in size and shape. Without wishing to be bound by theory, this behavior appears within the melt pool image sequence corresponding to one of two fault types: “temporal” and “spatial” faults. Temporal faults generally comprise single instance faults, which appear as one or two isolated anomalous images at the moment of occurrence. The second type, spatial faults, generally comprise larger defects which correspond to an anomalous melt pool image at each instance the laser passes over the defect location. As a print typically uses alternating raster patterns, the frequency at which the scanner returns to the anomalous location varies based on geometry and the chosen raster pattern.

The computer-readable storage medium in the system 100 includes instructions executable by the processor. In some embodiments, these instructions include forming a nominal basis representing a nominal operation of a laser powder bed fusion machine. In some embodiments, this is achieved using instructions for receiving a series of images of the melt pool of the laser powder bed fusion machine. In some embodiments, the images are captures using an NIR camera. In other embodiments, a thermal camera or a standard camera is used. In some embodiments, the images are captured at a rate of 2 kHz. As discussed below and shown in FIG. 3, the laser scan line can take various patterns. In some embodiments, the series of images includes images taken during a plurality of different print runs using a variety of different scan or raster patterns. In some embodiments, the series of images includes images taken during print runs using a single scan or raster pattern.

In some embodiments, the system further comprises instructions for identifying a nominal set of images representing nominal operation from the series. In some embodiments, a computer vision program is utilized to identify the nominal set of images—that is, to construct the set without including significant anomalous melt pool images.

In some embodiments, the system further comprises instructions for compressing each image in the nominal set to an image value proportional to the size of the melt pool to form a nominal image time series signal. In some embodiments, each melt pool image is compressed to a single-valued integer to reduce computational load. In some embodiments, the number of pixels per grayscale image at or above a chosen threshold is used as a single compressed feature. In some embodiments, using a threshold also reduces image noise from the signal. In this embodiment, the compression is given by the following expression:

$${C}_{α} = {\sum }_{r , c} [ I ( r , c ) ⩾ α ] \qquad ( 1 )$$

where I(r, c) is the intensity at pixel (r, c), [symbol] [ . . . ] is the indicator function (equal to 1 when the argument is true and 0 otherwise), and α is a user-determined intensity value threshold (integer between 0 and 255). This threshold is chosen to define the relevant melt pool size well, filtering out noise after each image is compressed to a single integer value C_{α}. In some embodiments, the threshold is set so that the integer count of pixels above a value of 50 out of 255 is taken for each image captured (i.e., α=50). This maintains relevant information from the original image, although some aspects are lost in this embodiment, such as shape. In some embodiments, the full melt pool image is used.

In other embodiments, the melt pool size is quantified, i.e., the image is compressed to an image value, by taking the major axis of the ellipse formed by the melt pool image. The ellipse is estimated for the silhouette of the image with pixel values above a threshold. In some embodiments, the threshold was chosen to be pixels with values of at least 50 out of the maximum 255, although other thresholds can be chosen. This melt pool length measurement forms the 1D signal used for modeling and detection. In some embodiments, the mean of each image is taken to generate an image value proportional to the size of the melt pool. The series of image values are used to form a nominal image time series signal.

In some embodiments, the system further comprises instructions for converting the nominal image time series signal to a nominal spectrogram. As is known, a spectrogram is a 2-D matrix of frequencies against time. In some embodiments, during a single-layer scan, the path of the laser in a L-PBF system such as that shown in FIG. 1 is dependent on the geometry of the layer, as well as the choice of raster pattern. Three sample raster patterns used in this embodiment are shown in FIG. 3a. A corresponding time series of the collected melt pool intensity signature for each raster pattern is shown in FIG. 3b. In some embodiments, the periodicity of this signal (caused by the rastering) is not obvious in the time series, so an autocorrelation function (ACF) can be calculated to better illustrate this periodicity. The ACF is shown in FIG. 3c. The peaks in the ACF correspond to the time lag between melt pools of similar size. Without wishing to be bound by theory, areas with frequent laser presence will exhibit a larger melt pool than a less traveled locale. As the laser scans over the powder according to its commanded raster pattern, specific geometry will create areas of frequent turns, corresponding to short scan line lengths. These locations with a longer laser presence will experience a higher thermal density than those less traveled, resulting in a higher localized temperature and consequently, melt pool size.

For many raster patterns, these large melt pool size locations are located at corners and along edges. Corners such as those shown in the “diagonal” raster direction have a dense pattern, resulting in more energy deposited at these locations. Similarly, edges are where the laser turns, scanning twice over the same area in short succession. These result in identifiable frequencies in the melt pool image data that can be related to the layer geometry and the scan path, as the time taken by the laser to travel from edge to edge is dependent on the scan line lengths and scan speed. The relationship between these frequency peaks fₙ and the average scan line length L for a time segment is given by:

$${f}_{n} = \frac{nv}{2 L} , n ∈ {ℤ}^{+} \qquad ( 2 )$$

where v is the scanning velocity. The locations of these peaks can be determined from print geometry by using this equation.

In some embodiments, the frequency content can be observed through the power spectral density (PSD) for a given time sequence. The PSD gives the power for the corresponding frequency, revealing the frequency content of the signal. However, in some embodiments, the PSD is unable to capture short term (non-repeating) temporal changes within the time sequence for which the PSD is calculated. To resolve this issue, in some embodiments, data is captured in time windows. The PSD estimate of windowed data can be taken, producing the frequency content across a moving time window. This is arranged according to time, with a given overlap for smoothing, to observe how the frequency content of the signal varies with time. This matrix is the spectrogram, which we use to capture the frequency content of the AM process as it progresses.

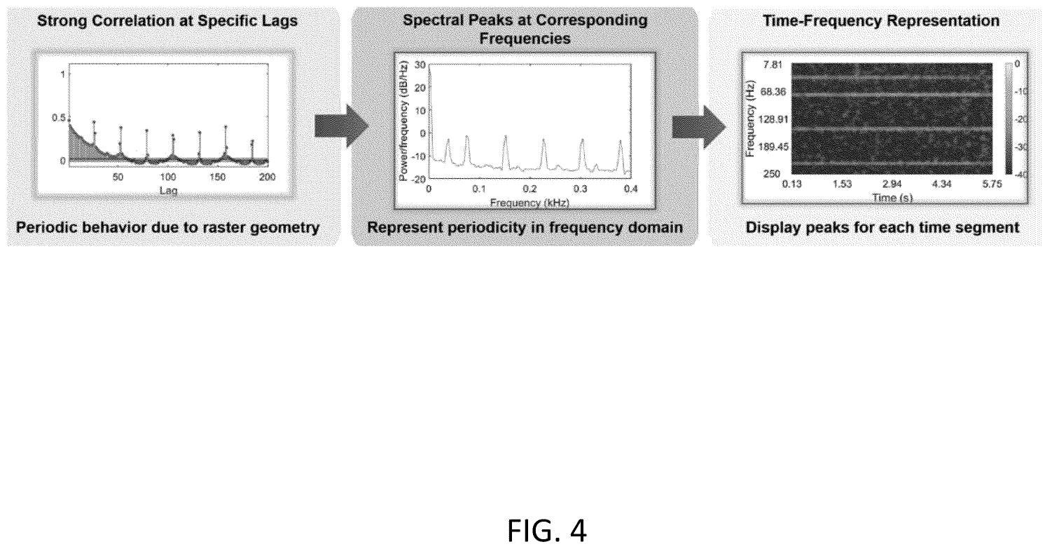

FIG. 4 shows the ACF, PSD, and a spectrogram of sample data according to an embodiment of the present technology. The peaks of the ACF correspond with the peaks of the PSD. The time lags of the peaks of the ACF correspond to the time it takes for the laser to travel from edge to edge. In the PSD, the high-power locations are a direct result of the frequency at which the laser travels between edges, which is related to the ACF time lag. By arranging the PSDs of short time segments sequentially into the spectrogram, the frequency content can be plotted as it develops across the print. Similar to the properties of the PSD, the spectrogram response depends on the scan geometry of the corresponding time segment via Equation (2). For raster patterns with constant scan line length, the spectrogram will contain clear peaks at locations corresponding to the geometry across the entire print. However, the frequency content will change over time for raster patterns with varying scan line lengths, such as in the diagonal arrangement in FIG. 3. This predicable periodicity can be exploited for fault detection in two ways: (1) a severe anomaly in the time signal will interrupt the periodicity of the time series signal, resulting in a different PSD response for the associated time segment(s) in the spectrogram; and (2) With known raster patterns and scanning speed, the periodic properties of the print are known. Specifically, the frequency peaks for nominal spectrograms will occur at known, consistent locations.

In some embodiments, the time series data is filtered through a low pass filter (e.g. having a cutoff frequency of 255 Hz) to remove high frequencies, as geometry-based system dynamics occur at frequencies below this threshold in some embodiments.

In some embodiments, to convert the time series to a spectrogram, the discrete short-time Fourier transform (STFT) is performed on a short time series segment from x to obtain the PSD estimate x(v) for M time instances x[tᵢ−(M−1) . . . x[tᵢ]] at time tᵢ at the end of the given segment as a function of frequency v:

$${x}_{{t}_{k}} ( v ) = {{\sum }_{m = 0}}^{M - 1} x [ {t}_{k} - ( M - 1 ) + m ] w [ m ] {e}^{- j 2 π vm} \qquad ( 3 )$$

where the function w[m] is given as:

$$w [ m ] = {a}_{0} - ( 1 - {a}_{0} ) cos ( \frac{2 π m}{M - 1} ) , 0 ⩽ m ⩽ M - 1 , {a}_{0} = 0.54 \qquad ( 4 )$$

Equation (4) is the Hamming window function, included as a smoothing function in the frequency domain. The window size M is chosen to define a time segment length, balancing frequency resolution with number of samples. In some embodiments, it is desirable for the window size to be sufficiently large enough to not miss any frequency peaks in the spectrogram while remaining short enough for distinct segmentation and timely fault detection. In this embodiment, the STFT is able to accurately capture the relevant frequency bands for this short time series M, although other approaches are used in other embodiments. In this embodiment, to smooth the spectrogram, the window is slid over the data according to a sample overlap. In this embodiment, the PSD estimates are arranged as columns in a matrix. This yields a 2D matrix with each column corresponding to a time window of size M at average time tᵢ and rows corresponding to frequency content v.

$$X = [ {x}_{{t}_{1}} , … , {x}_{{t}_{n}} ] , X ∈ {d \times n}^{} , {x}_{i} ∈ {d}^{} \qquad ( 5 )$$

The number of windows chosen is given by n, whereas the frequency resolution is given by d. In some embodiments, both of these parameters are chosen to observe the relevant frequency content at a high resolution without observing significant noise.

In some embodiments, the system further comprises instructions for decomposing the nominal spectrogram into a set of nominal principal components and forming a nominal basis based on the set of nominal principal components. At each time instant, the spectrogram response can be considered a vector of frequencies. In some embodiments, a principal component (PC) decomposition is performed and a limited number of PCs are selected to compress this information and extract relevant features. Through this algorithm, the spectrogram is projected onto a new basis, where each frequency vector comprises a linear combination of a reduced number of PCs and the basis. These PCs characterize the most relevant features of the spectrogram, the primary frequency modes. The spectrogram is then used to generate a nominal basis via PC decomposition.

In some embodiments, a PCA on the (2D) spectrogram matrix projects the spectrogram onto a basis composed of directions of maximum variance. In some embodiments, redefining the spectrogram into a linear combination of basis vectors with descending contributions to variance allows for reduction in the dimension without greatly affecting the information content. The covariance Σ is used to assess the variance of the spectrogram X. This can be diagonalized via its eigenvalues and eigenvectors as given by Equation (6):

$${X}^{T} X ∝ {\sum }^{n \times n} = W Λ {W}^{T} , W ∈ {n \times n}^{} \qquad ( 6 )$$

where W is the eigenvector matrix and Λ is the diagonal matrix of eigenvalues, sorted in descending order. Intuitively, the greatest eigenvalues λᵢ correspond with the greatest values of the covariance matrix Σ. As such, the largest values of the covariance Σ can be characterized by the first few eigenvalues λᵢ and the associated eigenvectors wᵢ. Accordingly, in some embodiments the PCs are defined as the column vectors of the eigenvectors. We find the projected basis T and its basis vectors tᵢ through the following operation:

$$T = XW = [ {t}_{1} , … , {t}_{d} ] , {t}_{i} ∈ {d}^{} \qquad ( 7 )$$

Afterwards, in some embodiments, the dimension of the data can be reduced as follows by limiting the number of PCs and basis vectors used to a chosen integer l<d:

$${\hat{T}}^{d \times l} = [ {t}_{1} , … , {t}_{l} ] , {\hat{W}}^{n \times l} = [ {\hat{w}}_{1} , … , {\hat{w}}_{l} ] , l < d \qquad ( 8 )$$

The number of PCs to retain is dependent on how much information the user wishes to retain, in this embodiment. This metric can be found by examining the first l eigenvalues of Λ:

$${Ψ}_{l} = \frac{{{\sum }_{i = 1}}^{l} {λ}_{i}}{{{\sum }_{i = 1}}^{n} {λ}_{i}} 100 ( \% ) \qquad ( 9 )$$

where λᵢ is the ith eigenvalue. After l (the reduced number of PCs) is decided upon, the reconstruction of the matrix is performed as follows:

$$\hat{X} = \hat{T} {\hat{W}}^{T} = [ {\hat{x}}_{1} , … , {\hat{x}}_{n} ] , {\hat{x}}_{i} = [ {t}_{1} \cdot {\hat{w}}_{1 , i} + … + {t}_{l} \cdot {\hat{w}}_{l , i} ] \qquad ( 10 )$$

Each spectrogram vector of frequencies xᵢ can be considered as a linear combination of l PC weights (w^{T})=[w_{1, i}, . . . , w_{l,i}] and basis \hat{T} (Equation (10).

In some embodiments, from known nominal (i.e., normal) data, a unified basis is constructed for all raster patterns altogether. That is, in some embodiments, the series of images of the melt pool includes images from each of the plurality of scan line patterns. In some embodiments, a combined basis is more flexible than a basis for each specific raster pattern, although more PCs are necessary to retain the same amount of information Ψ. The desired number of PCs are then determined by evaluating the number necessary for sufficiently reconstructing the original data. The derived basis \hat{T} is then defined as the nominal basis. In some embodiments, images from only a single raster pattern is used to form the nominal basis, while in other embodiments, data from more than one are combined.

The creation of a nominal basis provides a baseline of data against which operational data can be compared to detect anomalous or faulty operation of the AM machine or process. This means that, in some embodiments, substantially real-time data generated during AM operation can be monitored. The system 100 therefore includes, in some embodiments, instructions for comparing operational data of the laser powder bed fusion machine to the nominal basis.

In some embodiments, the system includes instructions for receiving a series of operational images of the melt pool of the laser powder bed fusion machine. In some embodiments, this is achieved in the same manner as the series of images of the melt pool referred to above to form the nominal basis, except the images are captured during production operation of the AM machine, such as when a part is being manufactured. In the embodiment of FIG. 1, the system 100 captures the operational images using the coaxial camera 102. In other embodiments, an off-axis camera is used.

In some embodiments, the system includes instructions for compressing each operational image to an operational image value proportional to the size of the melt pool to form an operational image time series signal and converting the operational image time series signal to an operational spectrogram. In some embodiments, these tasks are completed using the same algorithms used for compressing the nominal images and forming the nominal spectrogram as described above.

In some embodiments, the system includes instructions for decomposing the operational spectrogram into a set of operational principal components and projecting the operational principal components onto the nominal basis to form a reconstructed operational spectrogram. In some embodiments, the PSD estimate is taken (as in Equation (4)) to generate the associated spectrogram vector xₜ. To form the reconstructed operational spectrogram, this vector is decomposed into the PCs ŵₜ and projected onto the nominal basis \hat{T} as performed in the baseline phase described above. This forms the reconstructed spectrogram vector \hat{x}ₜ.

In some embodiments, the system includes instructions for calculating the reconstruction error between the reconstructed operational spectrogram and the nominal basis and comparing the reconstruction error to a detection threshold. The reconstruction error e_{\hat{x}} as given by

$${e}_{\hat{x}} ( {\hat{x}}_{t} ) = \sqrt{\int \frac{1}{d} {\sum }_{i = 1}^{d} {( {x}_{t} [ i ] - {\hat{x}}_{t} [ i ] )}^{2}} \qquad ( 11 )$$

In some embodiments, the system further comprises instructions for calculating a threshold reconstruction error for comparing to the reconstruction error. In some embodiments, this includes obtaining the statistics of the nominal basis to assign the detection threshold based on statistical confidence for comparing to the reconstruction error. In some embodiments, this process is similar to that described above for forming the nominal basis. The instructions include, in some embodiments, identifying a second set of nominal images representing nominal operation from the series of images of the melt pool; compressing each image in the second nominal set to an image value proportional to the size of the melt pool to form a second nominal image time series signal; and converting the second nominal time series signal to a second nominal spectrogram. In some embodiments, the second nominal spectrogram is then decomposed into a set of second nominal principal components. As above, decomposing the second nominal spectrogram includes extracting the PCs from the spectrograms. A projected nominal spectrogram is formed by projecting the set of second nominal principal components onto the nominal basis. In other words, the PCs Ŵ are combined with the previously generated nominal basis \hat{T} to reconstruct the original spectrogram \hat{X} (Equation (10)). Intuitively, the reconstructed spectrogram, (i.e., the projected nominal spectrogram), will be very similar to the original data since the dataset is healthy, much like the data used to construct the basis. Equation 11 above is used in some embodiments to calculate the deviation between the reconstructed spectrogram and the nominal basis, and results in a reconstruction error e_{\hat{x}}.

In some embodiments, the system includes instructions for calculating a threshold reconstruction error corresponding to the projected nominal spectrogram, calculating at least one statistical distribution of the threshold reconstruction error; and receiving a selection of the detection threshold based on the statistical distribution. In some embodiments, using the reconstruction error ex, the statistics of a nominal dataset are determined. From additional nominal data, reconstructed spectrograms of each raster pattern are generated to determine the distribution of reconstruction error. In some embodiments, a detection threshold is chosen as number of standard deviations (SDs) from the mean of the nominal error as the threshold. In some embodiments, the detection threshold is user-defined. So, in some embodiments, the system comprises instructions for receiving a user selection of a number of standard deviations from the threshold reconstruction error to define the detection threshold.

This detection threshold is chosen in some embodiments such that it is statistically unlikely for a nominal data point to surpass that threshold. This detection threshold can be modified to suit the desired sensitivity of the detection, balancing false alarms with missed faults. In some embodiments, individual detection thresholds are determined for each raster pattern to tune sensitivity for each pattern. In other embodiments, a unified detection threshold can be used for simplicity.

FIG. 7 show healthy and anomalous spectrograms constructed according to an embodiment of this technology. Temporal faults 501 appear as vertical streaks across all frequencies at a prescribed time interval, due to a single large response in the melt pool signal. This appears in the time series as a short, consecutive sequence of high values, indicating images with large melt pool areas. In contrast, spatial faults 502 are characterized by horizontal streaks across specific frequency bands. These horizontal streaks are related to the frequency at which the laser returns to the fault location. Unlike the time series response of temporal faults, the response of a spatial fault is more difficult to discern, with sparse anomalous signals distributed across several samples.

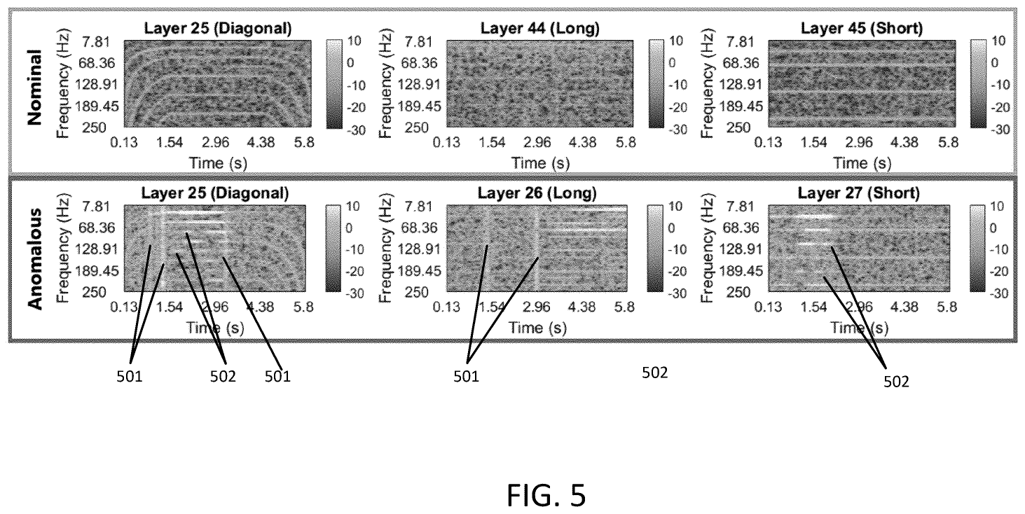

The nominal spectrogram response is shown on the top row of FIG. 5. Each of the three raster patterns exhibit different frequency responses. For the entirely linear raster patterns (long and short), the spectrogram peaks occur at consistent frequencies across the entire layer, related to their constant scan line length as given by Equation (2). In contrast, the diagonal raster pattern displays varying frequency peaks at the start and end of the print, due to the geometry (see FIG. 3). The diagonal raster pattern begins with short scans, gradually lengthening until reaching a constant length (at the horizontal frequency peaks at the center of the spectrogram). As the time-frequency algorithm relies on generating a basis consisting of the scan line lengths, we expect the diagonal direction to exhibit higher reconstruction errors at these locations due to the inconsistent frequency peaks.

Anomalous spectrograms are shown in FIG. 8 (bottom). In the short direction (right), there are horizontal streaks 502 across frequency bands that do not appear in the healthy case. This corresponds to a spatial fault that occurs at a different frequency than nominal spectrograms. Similarly, in the long direction (center) spatial faults 502 are observable toward the end of the layer. In this direction, two temporal faults 501 are also observable, given by the vertical streaks. Unlike the spatial faults, these do not last longer than one time instance, and appear in all frequencies. Both a temporal 501 and spatial faults 502 are observed in the diagonal direction (left).

Other embodiments of the present technology provide methods for monitoring an additive manufacturing process. In some embodiments, the method includes: a. receiving a series of images of the melt pool of a laser powder bed fusion machine; b. identifying a nominal set of images representing nominal operation from the series; c. compressing each image in the nominal set to an image value proportional to the size of the melt pool to form a nominal image time series signal; d. converting the nominal image time series signal to a nominal spectrogram; e. decomposing the nominal spectrogram into a set of nominal principal components; f. forming a nominal basis based on the set of nominal principal components; g. receiving a series of operational images of the melt pool of the laser powder bed fusion machine; h. compressing each operational image to an operational image value proportional to the size of the melt pool to form an operational image time series signal; i. converting the operational image time series signal to an operational spectrogram; j. decomposing the operational spectrogram into a set of operational principal components and projecting the operational principal components onto the nominal basis to form a reconstructed operational spectrogram; k. calculating the reconstruction error between the reconstructed operational spectrogram and the nominal basis; and l. comparing the reconstruction error to a detection threshold. In some embodiments, the steps g. through l. are performed substantially in real time during operation of an additive manufacturing machine.

In some embodiments, the step of compressing each image value comprises identifying the number of pixels in each image having an intensity above a selected threshold. In some embodiments, the step of compressing each image value comprises fitting an ellipse on the melt pool in each image and calculating the length of the major axis of the fit ellipse.

In some embodiments, the method further comprises obtaining the statistics of the nominal basis to assign the detection threshold based on statistical confidence for comparing to the reconstruction error by: identifying a second set of nominal images representing nominal operation from the series of images of the melt pool; compressing each image in the second nominal set to an image value proportional to the size of the melt pool to form a second nominal image time series signal; converting the second nominal time series signal to a second nominal spectrogram; decomposing the second nominal spectrogram into a set of second nominal principal components; projecting the set of second nominal principal components onto the nominal basis to form a projected nominal spectrogram; calculating a threshold reconstruction error corresponding to the projected nominal spectrogram; calculating at least one statistical distribution of the threshold reconstruction error; and receiving a selection of the detection threshold based on the statistical distribution. In some embodiments, the method further comprises receiving a user selection of a number of standard deviations from the threshold reconstruction error to define the detection threshold.

Some embodiments of the present technology include non-transitory computer-readable storage media and/or devices having stored thereon instructions that when executed by one or more processors perform the methods and processes described herein. The processor may include, for example, a processing unit and/or programmable circuitry. The storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions.

In another embodiment of the present technology, an AutoRegressive (AR) model is used to predict the time series of melt pool data, modelling the geometric properties of the raster. To perform detection, the residuals derived from the model error are used in some embodiments. These residuals will naturally be Gaussian, as the melt pool size is typically Gaussian, with fluctuations from the periodic raster.

Using these residuals, well-defined statistical methods are used to determine how well the residuals of any print layer conform to the expected nominal behavior. Faults will result in dissimilar residuals, as the nominal AR model will not be able to remove the anomalous response from the residuals. Furthermore, in some embodiments, the reference nominal parameters can be determined from only one layer, reducing the quantity of data necessary for detection.

As used herein, the terms “logic,” “block,” and/or “module” may refer to an app, software, firmware and/or circuitry configured to perform any of the aforementioned operations. Software may be embodied as a software package, code, instructions, instruction sets and/or data recorded on non-transitory computer-readable storage media. Firmware may be embodied as code, instructions or instruction sets, and/or data that are hard-coded (e.g., nonvolatile) in memory devices.

“Circuitry”, as used herein, may include, for example, singly or in any combi-nation, hardwired circuitry, programmable circuitry such as computer processors comprising one or more individual instruction processing cores, state machine circuitry, and/or firmware that stores instructions executed by programmable circuitry. The logic and/or module may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc.

Although the technology has been described and illustrated with respect to exemplary embodiments thereof, it should be understood by those skilled in the art that the foregoing and various other changes, omissions and additions may be made therein and thereto, without departing from the spirit and scope of the present invention.

What is claimed is:

1. A system for monitoring an additive manufacturing process, comprising:
a processor;
a computer-readable storage medium comprising instructions executable by the processor for:
forming a nominal basis representing a nominal operation of a laser powder bed fusion machine by:
receiving a series of images of the melt pool of the laser powder bed fusion machine;
identifying a nominal set of images representing nominal operation from the series;
compressing each image in the nominal set to an image value proportional to the size of the melt pool to form a nominal image time series signal;
converting the nominal image time series signal to a nominal spectrogram;
decomposing the nominal spectrogram into a set of nominal principal components; and
forming a nominal basis based on the set of nominal principal components;
comparing operational data of the laser powder bed fusion machine to the nominal basis by:
receiving a series of operational images of the melt pool of the laser powder bed fusion machine;
compressing each operational image to an operational image value proportional to the size of the melt pool to form an operational image time series signal;
converting the operational image time series signal to an operational spectrogram;
decomposing the operational spectrogram into a set of operational principal components and projecting the operational principal components onto the nominal basis to form a reconstructed operational spectrogram;
calculating the reconstruction error between the reconstructed operational spectrogram and the nominal basis; and
comparing the reconstruction error to a detection threshold.

2. The system of claim 1, wherein the instructions for compressing each image value comprises identifying the number of pixels in each image having an intensity above a selected threshold.

3. The system of claim 1, further comprising a camera configured to capture thermal or near-infrared images.

4. The system of claim 1, further comprising instructions for obtaining the statistics of the nominal basis to assign the detection threshold based on statistical confidence for comparing to the reconstruction error by:
identifying a second set of nominal images representing nominal operation from the series of images of the melt pool;
compressing each image in the second nominal set to an image value proportional to the size of the melt pool to form a second nominal image time series signal;
converting the second nominal time series signal to a second nominal spectrogram;
decomposing the second nominal spectrogram into a set of second nominal principal components;
projecting the set of second nominal principal components onto the nominal basis to form a projected nominal spectrogram;
calculating a threshold reconstruction error corresponding to the projected nominal spectrogram;
calculating at least one statistical distribution of the threshold reconstruction error; and
receiving a selection of the detection threshold based on the statistical distribution.

5. The system of claim 4, further comprising instructions for receiving a user selection of a number of standard deviations from the threshold reconstruction error to define the detection threshold.

6. The system of claim 1, further comprising instructions for operating the laser along a plurality of scan line patterns and the series of images of the melt pool includes images from each of the plurality of scan line patterns.

7. The system of claim 1, wherein the instructions for compressing each image value comprises fitting an ellipse on the melt pool in each image and calculating the length of the major axis of the fit ellipse.

8. A method for monitoring an additive manufacturing process, comprising the steps of:
a. receiving a series of images of the melt pool of a laser powder bed fusion machine;
b. identifying a nominal set of images representing nominal operation from the series;
c. compressing each image in the nominal set to an image value proportional to the size of the melt pool to form a nominal image time series signal;
d. converting the nominal image time series signal to a nominal spectrogram;
e. decomposing the nominal spectrogram into a set of nominal principal components;
f. forming a nominal basis based on the set of nominal principal components;
g. receiving a series of operational images of the melt pool of the laser powder bed fusion machine;
h. compressing each operational image to an operational image value proportional to the size of the melt pool to form an operational image time series signal;
i. converting the operational image time series signal to an operational spectrogram;
j. decomposing the operational spectrogram into a set of operational principal components and projecting the operational principal components onto the nominal basis to form a reconstructed operational spectrogram;
k. calculating the reconstruction error between the reconstructed operational spectrogram and the nominal basis; and
l. comparing the reconstruction error to a detection threshold.

9. The method of claim 8, wherein the steps g. through 1. are performed substantially in real time during operation of an additive manufacturing machine.

10. The method of claim 8, wherein the step c. compressing each image value comprises identifying the number of pixels in each image having an intensity above a selected threshold.

11. The method of claim 8, wherein the step c. compressing each image value comprises fitting an ellipse on the melt pool in each image and calculating the length of the major axis of the fit ellipse.

12. The method of claim 8, further comprising obtaining the statistics of the nominal basis to assign the detection threshold based on statistical confidence for comparing to the reconstruction error by:
identifying a second set of nominal images representing nominal operation from the series of images of the melt pool;
compressing each image in the second nominal set to an image value proportional to the size of the melt pool to form a second nominal image time series signal;
converting the second nominal time series signal to a second nominal spectrogram;
decomposing the second nominal spectrogram into a set of second nominal principal components;
projecting the set of second nominal principal components onto the nominal basis to form a projected nominal spectrogram;
calculating a threshold reconstruction error corresponding to the projected nominal spectrogram;
calculating at least one statistical distribution of the threshold reconstruction error; and
receiving a selection of the detection threshold based on the statistical distribution.

13. The method of claim 12, further comprising receiving a user selection of a number of standard deviations from the threshold reconstruction error to define the detection threshold.

14. A non-transitory computer readable storage medium comprising instructions executable by a processor for:
receiving a series of images of the melt pool of a laser powder bed fusion machine;
identifying a nominal set of images representing nominal operation from the series;
compressing each image in the nominal set to an image value proportional to the size of the melt pool to form a nominal image time series signal;
converting the nominal image time series signal to a nominal spectrogram;
decomposing the nominal spectrogram into a set of nominal principal components;
forming a nominal basis based on the set of nominal principal components;
receiving a series of operational images of the melt pool of the laser powder bed fusion machine;
compressing each operational image to an operational image value proportional to the size of the melt pool to form an operational image time series signal;
converting the operational image time series signal to an operational spectrogram;
decomposing the operational spectrogram into a set of operational principal components and projecting the operational principal components onto the nominal basis to form a reconstructed operational spectrogram;
calculating the reconstruction error between the reconstructed operational spectrogram and the nominal basis; and
comparing the reconstruction error to a detection threshold.

15. The storage medium of claim 14, wherein the instructions for compressing each image value comprises identifying the number of pixels in each image having an intensity above a selected threshold.

16. The storage medium of claim 14, wherein the instructions for compressing each image value comprises fitting an ellipse on the melt pool in each image and calculating the length of the major axis of the fit ellipse.

17. The storage medium of claim 14, further comprising instructions for obtaining the statistics of the nominal basis to assign the detection threshold based on statistical confidence for comparing to the reconstruction error by:
identifying a second set of nominal images representing nominal operation from the series of images of the melt pool;
compressing each image in the second nominal set to an image value proportional to the size of the melt pool to form a second nominal image time series signal;
converting the second nominal time series signal to a second nominal spectrogram;
decomposing the second nominal spectrogram into a set of second nominal principal components;
projecting the set of second nominal principal components onto the nominal basis to form a projected nominal spectrogram;
calculating a threshold reconstruction error corresponding to the projected nominal spectrogram; and
calculating at least one statistical distribution of the threshold reconstruction error; and
receiving a selection of the detection threshold based on the statistical distribution.

18. The storage medium of claim 17, further comprising instructions for receiving a user selection of a number of standard deviations from the threshold reconstruction error to define the detection threshold.
